(19) United States
(12) Patent Application Publication
(10) Pub. No.: US 2002/0139888 A1
(43) Pub. Date: Oct. 3, 2002

(54) Precision belt-driven tape cartridge

(76) Inventor: Donald Stanley, San Diego, CA (US)

Correspondence Address: FENWICK & WEST LLP, TWO PALO ALTO SQUARE, PALO ALTO, CA, 94306, US

(21) Appl. No.: 09/827,133

(22) Filed: Apr. 3, 2001

(51) Int. Cl. G11B 23/087

(52) U.S. Cl. 242/347; 360/132; 242/340

(57) ABSTRACT

A base plate for a belt-driven cartridge for recording tape includes a molded or cast base layer with integral mounting bosses and ribs on the upper surface of the base layer for rigidly supporting axles and tape guides in precise perpendicular alignment and selected elevations relative to the lower reference surface of the base layer. The integral ribs extend between raised bosses to enhance torsional and flexural and depressional rigidity of the base layer over the entire area within the peripheral boundaries thereof.

### FIELD OF THE INVENTION

This invention relates to belt-driven tape cartridges for magnetic recording tape, and more particularly to such tape cartridges of extended configuration having precision base plates for improved data tracking and higher density recording capability.

### BACKGROUND OF THE INVENTION

Conventional belt-driven data tape cartridges are commonly fabricated on a metallic base plate that supports a plurality of axles for rotating components and a plurality of tape guides of various configurations, all at selected elevations relative to a reference plane of the base plate. Recording tape that transfers between a pair of rotatable reels within the tape cartridge is retained at the selected elevation relative to the reference plane in order to align servo and data tracks on the recording tape with transducers of a compatible tape drive unit with which the tape cartridge operationally interacts. Contemporary demands for higher recording density and larger data capacity in such belt-driven tape cartridges has been satisfied by increasing the volumes of recording tape contained within the tape cartridges, and by increasing the number of recording tracks and decreasing the widths and spacings thereof across the width of tape.

The length of the tape cartridge has been extended for a given width of tape cartridge to accommodate larger quantities of recording tape, and the alignment precision with which the recording tape traverses the tape transducer each place more stringent requirements upon the rigidity and plane-parallel flatness of the base plate as the reference plane for the selected elevation at which the recording tape traverses a tape transducer in transferring between tape reels.

Certain known techniques have been used to assure rigid and flat base plates for such belt-driven tape cartridges, including embossing the surfaces of a base plate that is stamped out of rolled sheet metal and flattened to alter its metallic gain structure near the surfaces. Variations in the deviations from flatness of these types of base plates appear to be associated with the locations (i.e. near the edges, near the beginning or end of the roll) in the roll stock from which the base plate was stamped. Techniques for controlling these variations are disclosed in the literature (see, for example, U.S. patent application Ser. No. 09/487,758). Other known base plates for belt-driven tape cartridges are structured as a molding of, for example, polymeric material having stiffening webs integrally formed on the bottom surface of structure. Devices of this type are also disclosed in the literature (see, for example, U.S. Pat. No. 5,522,562).

### SUMMARY OF THE INVENTION

In accordance with one embodiment of the present invention, a base plate casting is formed with the repeatable precision of the molding or casting die. High dimensional accuracy is achieved without supplemental machining by the integral formation of webs disposed at selected locations over the area of the base plate within the peripheral boundaries thereof. Additionally, components of the tape cartridge such as axles and tape guides are molded or cast into the base plates in precise perpendicularity to the base plate with the repeatable precision of the molding or casting die. Reference elevations relative to the base plate are maintained by inserts that are also molded or cast into the base plate with the repeatable precision of the molding or casting die. Base plates fabricated according to the present invention in this manner exhibit repeatable flatness, and elevational and perpendicular precision for components that comprise the tape cartridge without a need for supplemental stamping, pressing or machining.

### DESCRIPTION OF THE DRAWINGS

FIG. 1 is a perspective view of an extended or elongated tape cartridge (cover removed for clarity);

FIG. 2 is a plan view of an improved base plate according to one embodiment of the present invention; and

FIG. 3 is a cross-sectional view of an integral boss in the base plate for supporting a perpendicular component.

### DETAILED DESCRIPTION OF THE INVENTION

Referring now to FIG. 1, there is shown a perspective view of a tape cartridge 10 according to one embodiment of the present invention (with cover removed for clarity) inserted into a compatible tape drive unit 50. Tape cartridge 10 includes a pair of tape reels 11 and 12 with a length of tape 20 wound thereabout and traversing a tape path between reels 11, 12 along the forward edge 14. The tape cartridge 10 is received by the tape drive unit 50 along a pair of tracks 52 which aligns both sides of the base plate 18. The forward edge 14 of the tape cartridge 10 is designed in conformance with a standard configuration associated with the compatible tape drive unit 50 for proper operational engagement of the tape cartridge 10 with the tape drive unit 50. A pivoted door 53 is cammed open by a cam 54 as the tape cartridge 10 is inserted into the tape drive unit 50. With the tape cartridge 10 completely inserted along the tracks 52, a tape transducer 56 of the tape drive unit 50 contacts the magnetic tape 20 within the tape access region of the cartridge 10 behind the door 53, and a driving capstan roller 58 of the tape drive unit 50 contacts a drive roller 38 within the tape cartridge 10 to impart appropriate rotation of the tape packs 11 and 12. An endless drive belt 30, of an elastic, resilient material is disposed in tension about a belt path around the rollers 32, 34, 36 and 38 and about the outer convolutes of tape 20 wound onto reels 11, 12. Thus, as drive roller 38 is rotated by the capstan roller 58 of the tape drive unit 58, the elastic belt 30 transfers tape 20 between reels 11, 12 along the tape path in contact with tape transducer 56 in conventional manner. The tape reels 11 and 12 are mounted for rotation about respective axles 15 and 16 that are rigidly mounted perpendicular to base plate 18. The magnetic recording tape 20 transfers between reels 11, 12 along the tape path therebetween that is configured in one embodiment by a set of stationary tape guides 22, 24, 25, and 26, as shown, that are also mounted perpendicular to the base plate 18.

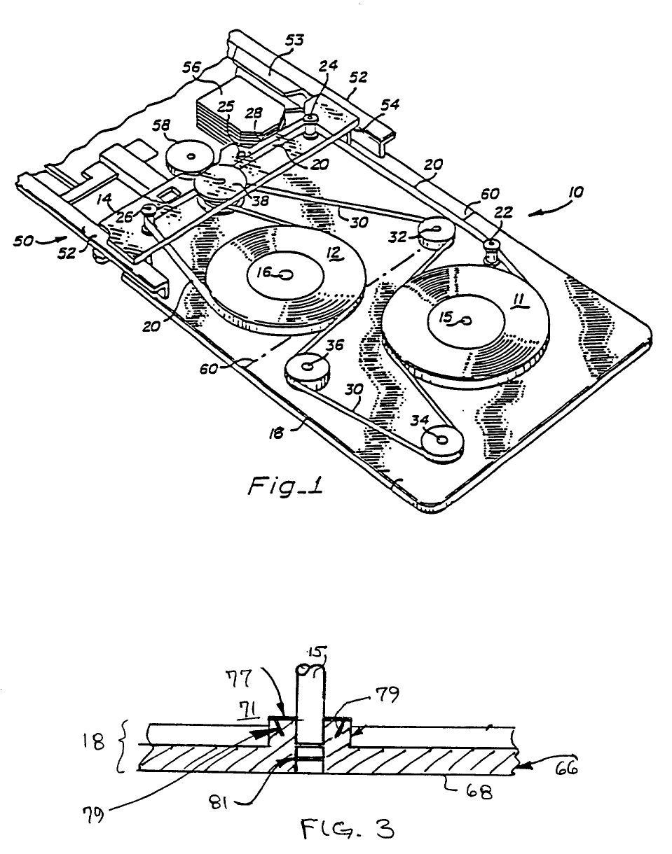

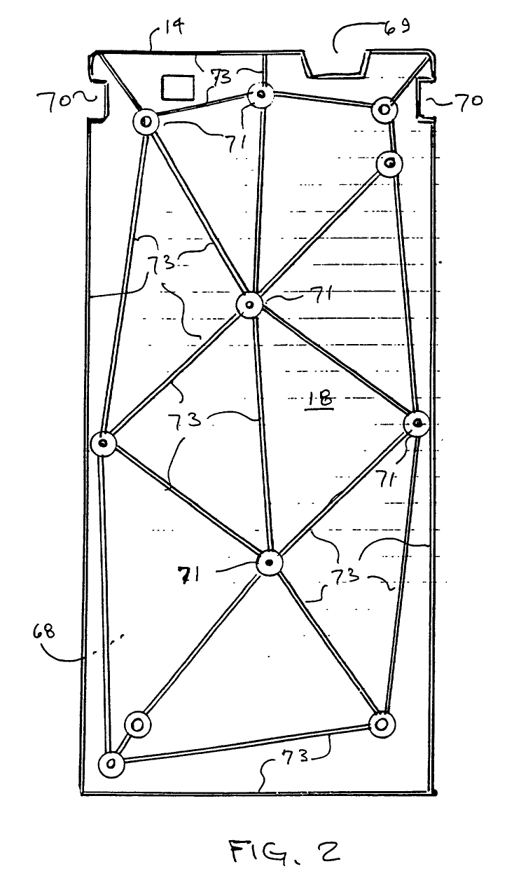

Referring now to FIG. 2, there is shown a plan view of the base plate 18 fabricated in accordance with the present invention as the support or foundation for the fixed and rotatable components that are mounted on the base plate 18 to form an operative tape cartridge 10. The base plate 18 includes a forward edge 14 that inserts into the compatible tape drive unit 50, and includes a notch or recess 69 to accommodate engagement of a tape transducer 56 of such a tape drive unit with recording tape 20 that traverses the tape path along the forward edge 14 of the base plate 18. Notches or recesses 70 in the peripheral side edges of the base plate 18 near the forward edge 14 thereof accommodate retaining devices in the compatible tape drive unit 50 that retain the tape cartridge 10 in operational position within the compatible tape drive unit 50, in conventional manner. Each of the mounting locations for an axle or tape guide includes an elevated boss 71, as discussed in detail later herein with reference to FIG. 3. The base plate 18 includes a base layer 66 of selected thickness having a lower substantially planar reference surface 68, and having an upper surface with upright ribs or ridges 73 integrally formed therein in selected patterns between bosses and substantially about the perimeter edges of the base layer 66. Each of the ribs 73 has greater height above the base portion 66 than sectional width for enhanced rigidity. The selected patterns of ribs or ridges 73 include triangular and other multi-sided closed polygonal figures to promote inherent rigidity of the composite base plate 65 against torsional or flexural distortions from planar flatness of the lower reference surface 68 over the length and width thereof. In one embodiment, the base plate 18 is cast of a die-cast metal such as zinc or aluminum-based alloy, and in another embodiment is molded of a polymeric material such as polycarbonate, incorporating into the material about 15% milled carbon fiber and about 35% milled glass fiber.

Referring now to FIG. 3, there is shown a side sectional view of a boss 71 at the mounting of an axle 15, for example, for tape reel 11. The base layer 66 has substantially uniform thickness over the area of the base plate 18, and establishes a planar reference at the lower surface 68 thereof from which the selected elevation of tape-handling components of the tape cartridge are determined. The boss 71 at such mounting location is integrally formed of the same material with the base layer 66, and is topped by a washer or bearing surface 77 that is formed of a suitable material such as stainless steel. The topmost surface of the washer 77 is set at a selected elevation relative to the lower reference surface 68 to assure that tape-handling components such as tape guides and tape reels all establish the proper elevation for alignment of tape with a tape transducer near the forward edge 14 of the tape cartridge. The washer 77 includes a plurality of recessed tabs 79 near the perimeter thereof that are positioned for rigid attachment to the boss 71. The ribs 73 are disposed about the upper surface of the base layer 66 to an elevation above the reference plane of the lower surface 68 that is not higher than the reference elevation of the top surface of the washer 77, thereby to provide clearance for the moving components of the tape cartridge. The axle 15 may also include retaining tabs or grooves 81, or the like, to assure rigid attachment to the boss 71. The axle 15 and washer 77 may be pre-installed into a casting mold at the precise location desired in the finished casting for integrated fabrication as part of the casting, with tabs 79 providing distributed restraining forces within the boss 71 to retain the washer 77 in precise position and at a selected elevation relative to the lower reference surface 68 of the base layer 66.

In an alternative embodiment in which the base plate 18 is cast or molded of a polymeric material such as polycarbonate with about 15% milled carbon fibers and about 35% milled glass fibers, the axles 15, 16 and similar vertical components may be ultrasonically vibrated and pressed into position in the bosses 71. Similarly, washers 77 with supplemental attachment tabs 79 may also be ultrasonically vibrated and pressed into position in essentially thermo compression or ultrasonically-implemented welding of such components to the base plate 18. Grooves or other recesses 81 in the portions of such components that engage the bosses 71 promote rigid attachment via flow of the molding or casting material into such recesses.

It is believed that the bosses 71 integrally formed at the ends of the upstanding ribs or ridges 73 serve as nodes or stanchions for distributing microflexure forces to the base layer 66 and to other ribs 73 attached to such bosses 71, with resultant increased flexural and torsional rigidity of the base plate 18. The ribs 73 and bosses 71 form closed polygonal figures of 3 or more sides to promote such increased rigidity of the base plate 18 and to stiffen the base layer 66 against defecture of the lower reference surface 68.

Therefore, the base plate for a belt-driven tape cartridge of extended configuration according to the present invention exhibits precision flatness substantially with the repeatability of the molding dies without requiring a uniformly thick configuration of the base plate and without requiring subsequent machining or surface treatments to attain the desired flatness and planarity. Integrally-formed raised bosses provide substantial rigidity for vertically-oriented components positioned thereon, and such bosses also serve as stanchions at the ends of integrally-formed ribs distributed over the upper surface of the lower base portion 66 of the base plate 18. Components of the tape cartridge may be pre-assembled within a die or mold for integrated fabrication into the molded or cast base plate for enhanced positional precision, with the repeatability of the dies for molding or casting the base plate.

I claim:

1. A base plate for a tape cartridge comprising:
a base layer having a lower reference surface and having a plurality of raised bosses integrally formed at selected locations on an upper surface thereof, and including a plurality of ribs integrally formed on the upper surface of the base layer between selected ones of the raised bosses;
a pin positioned in each of selected ones of the raised bosses in perpendicular orientation relative to the lower reference surface; and
a washer positioned about each of the pins on an upper surface of the associated raised boss at a selected elevation and in plane parallel orientation relative to the lower reference surface.

2. The base plate as in claim 1 in which the plurality of ribs extend substantially lineally between raised bosses at opposite ends of the ribs in polygonal closed figures about the upper surface of the base layer.

3. The base plate as in claim 1 in which each of the ribs extends above the upper surface of the base layer to an elevation less than said selected elevation.

4. The base plate as in claim 1 in which each of the pins and each of the washers includes an attachment structure for promoting rigid attachment to the material of the associated raised boss.

5. The base plate as in claim 1 in which the base layer and raised bosses and ribs are integrally formed of polymeric molding.

6. The base plate as in claim 1 in which the base layer and raised bosses and ribs are integrally formed of die cast alloy.

7. A method of fabricating a cartridge for a length of magnetic recording tape disposed to move along a tape path defined by tape guides between a pair of rotatable reels supported on a common base plate, the method comprising:
forming a die cavity including a recess for forming a base layer of the base plate having a selected reference plane and including a plurality of depressions within the recess for forming bosses at selected locations at which the reels are to be rotatable, and including grooves in the recess between selected depressions for forming ribs therein between bosses;
supporting axles in the depressions at perpendicular orientations to the reference plane;
supporting washers about the axles at plane-parallel orientations and selected elevations relative to the reference plane; and
filling the recess and the depressions and grooves and about the axles and washers with material in a fluid state capable of changing to a solid state for forming a base plate including integral bosses and ribs on a base layer and captivating the axles and washers in the bosses integrally formed in the base plate.

8. The method according to claim 7 in which forming a die cavity includes forming additional depressions within the recess for forming additional bosses at selected locations at which tape guides are to be positioned, and includes forming additional grooves in the recess between a plurality of depressions for forming ribs therebetween.

9. The method according to claim 7 in which in forming the die cavity the grooves are formed within the recess to extend between depressions in closed polygonal configurations at substantially uniform elevations relative to the reference plane.

10. The method according to claim 9 in which the grooves are formed to the substantially uniform elevations less than said selected elevation relative to the reference plane.

11. The method according to claim 7 in which the material includes polymeric molding material.

12. The method according to claim 7 in which the material includes die-cast alloy.

13. The method according to claim 7 in which in supporting axles, the axles are formed with portions thereof having reduced cross-section for securing the axles within the material in the solid state.

14. The method according to claim 7 in which in supporting washers integral tabs of the washers are positioned within the depressions for securing the washers within the material in the solid state.
